(19) United States
(12) Patent Application Publication
(10) Pub. No.: US 2026/0100295 A1
(43) Pub. Date: Apr. 9, 2026

(54) STRANDED WIRE AND ROBOT

(71) Applicant: Panasonic Intellectual Property Management Co., Ltd., Osaka (JP)

(72) Inventors: Akitoshi KASAHARA, Osaka (JP); Tomohiro KANAZAWA, Osaka (JP); Youji YAMASHITA, Shiga (JP); Katsuhiro MAEKAWA, Osaka (JP)

(73) Assignee: Panasonic Intellectual Property Management Co., Ltd., Osaka (JP)

(21) Appl. No.: 19/144,538

(22) PCT Filed: Jan. 19, 2024
(86) PCT No.: PCT/JP2024/001415

§ 371 Date: Jun. 30, 2025

(30) Foreign Application Priority Data
Jan. 30, 2023 (JP) 2023-011936

(51) Int. Cl. H01B 7/22; H01B 1/02

(52) U.S. Cl. CPC H01B 7/22; H01B 1/02

(57) ABSTRACT

A stranded wire includes: a stranded wire body including a plurality of strands that are twisted together, the plurality of strands including a metal wire containing tungsten as a principal component; and a resin film that covers a surface of the stranded wire body. A ratio of a thickness of the resin film to a wire diameter of the stranded wire body is 8% or higher.

### TECHNICAL FIELD

The present invention relates to stranded wires and robots using the stranded wires as electrical wires.

### BACKGROUND ART

Stranded wires have various advantages in that, for example, both high strength and high flexibility can be achieved. When a stranded wire is to be reduced in diameter, increased strength is also desired to maintain its strength. Patent Literature 1 discloses a stranded wire formed of tungsten wires.

### CITATION LIST

### Patent Literature

### [PTL 1]

Japanese Unexamined Patent Application Publication No. 2022-76997

### SUMMARY OF INVENTION

### Technical Problem

A stranded wire is prone to break when kinking occurs, and is therefore desirably resistant to kinking.

An object of the present invention is to provide, for example, a stranded wire that can suppress kinking.

### Solution to Problem

A stranded wire according to an aspect of the present invention includes: a stranded wire body including a plurality of strands that are twisted together, the plurality of strands including a metal wire containing tungsten as a principal component; and a resin film that covers a surface of the stranded wire body, wherein a ratio of a thickness of the resin film to a wire diameter of the stranded wire body is 8% or higher.

A robot according to an aspect of the present invention includes the aforementioned stranded wire used as the electrical wire, the electrical wire being connected to a driver.

### Advantageous Effects of Invention

The present invention can provide, for example, a stranded wire that can suppress kinking.

### BRIEF DESCRIPTION OF DRAWINGS

FIG. 1 is a schematic external view illustrating a stranded wire according to an embodiment.

FIG. 2 is a schematic cross-sectional view illustrating the stranded wire according to the embodiment.

FIG. 3 is a schematic partial view illustrating a metal stranded wire used in the stranded wire according to the embodiment.

FIG. 4 is a flowchart illustrating a manufacturing method of the stranded wire according to the embodiment.

FIG. 5 is a schematic cross-sectional view illustrating a stranded wire according to Variation 1 of the embodiment.

FIG. 6 is a schematic partial view illustrating a metal stranded wire used in the stranded wire according to Variation 1 of the embodiment.

FIG. 7 is a schematic cross-sectional view illustrating a stranded wire according to Variation 2 of the embodiment.

FIG. 8 is a schematic cross-sectional view illustrating a stranded wire according to Variation 3 of the embodiment.

FIG. 9 is a schematic cross-sectional view illustrating a stranded wire according to Variation 4 of the embodiment.

FIG. 10 is a schematic view illustrating an overview of a testing device employed in a kink resistance test using the stranded wire according to the embodiment.

FIG. 11A illustrates a microscope photograph when the stranded wire is not kinked.

FIG. 11B illustrates a microscope photograph when the stranded wire is kinked.

FIG. 12 is a graph illustrating the relationship between the thickness of a resin film and the diameter of a mandrel at the time of kink occurrence in the kink resistance test.

FIG. 13 is a diagram illustrating a robot as an example of a product using the stranded wire according to the embodiment.

### DESCRIPTION OF EMBODIMENTS

Embodiments of the present invention will be described in detail below with reference to the drawings. All of the embodiments to be described below are specific examples of the present invention. Therefore, numerical values, shapes, materials, components, positions and connection methods of the components, steps, the order of the steps, and so on indicated in the embodiments below are examples, and are not intended to limit the present invention. Accordingly, among the components in the embodiments below, components not indicated in the independent claims are described as arbitrary components.

Each drawing is a schematic view and is not necessarily a precise illustration. Therefore, for example, the scales and the like in the drawings do not necessarily match. Moreover, substantially identical components in the drawings are given the same reference signs, and redundant explanations are omitted or simplified.

In this description, terms indicating the relationships between components, terms indicating the shapes of components as in, for example, circular, and numeral ranges are not expressions representing only strict meanings but rather expressions including substantially equivalent ranges, such as differences of a few percent.

### Embodiment

### [Stranded Wire]

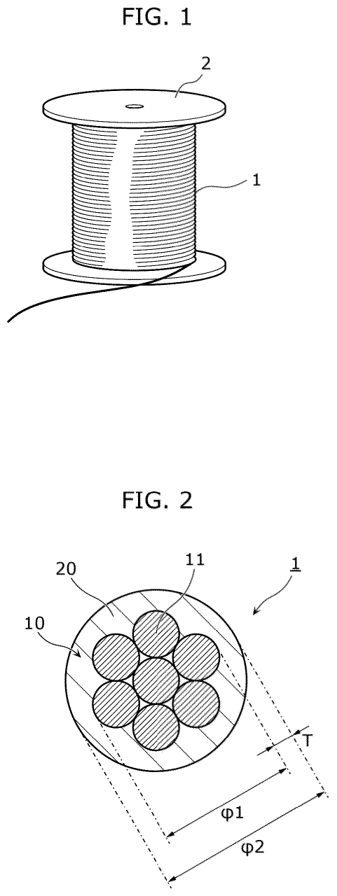

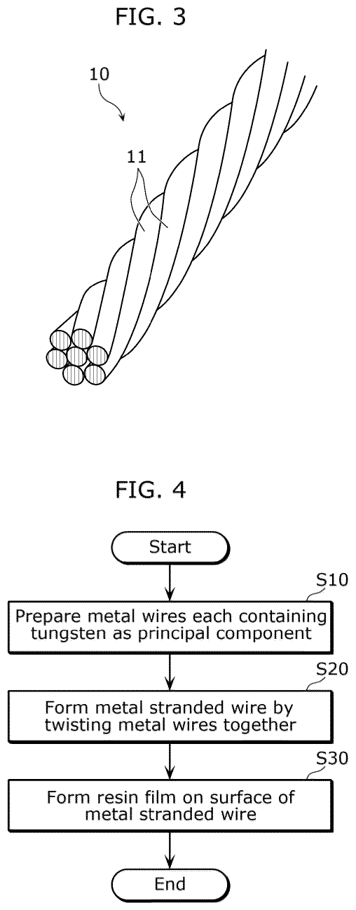

First, a stranded wire according to an embodiment will be described with reference to FIG. 1 to FIG. 3. FIG. 1 is a schematic external view illustrating stranded wire 1 according to this embodiment. FIG. 2 is a schematic cross-sectional view illustrating stranded wire 1 according to this embodiment. FIG. 3 is a schematic partial view illustrating metal stranded wire 10 used in stranded wire 1 according to this embodiment. The cross section of stranded wire 1 illustrated in FIG. 2 is taken in a direction orthogonal to an axial direction (direction in which stranded wire 1 extends) of stranded wire 1.

As illustrated in FIG. 1, for example, stranded wire 1 is stored by being wound around reel frame 2. Reel frame 2 may sometimes be referred to as, for example, a bobbin, a reel, a spool, or a drum. The storage method of stranded wire 1 is not particularly limited, and stranded wire 1 is stored in such a manner as to avoid excessive bending. The overall length of stranded wire 1 may range from the order of centimeters to the order of meters, or may be in the order of kilometers.

Stranded wire 1 is used as, for example, an extremely thin electrical wire. Although there is no particular limit to applications when stranded wire 1 is used as an electrical wire, for example, stranded wire 1 is used as an electrical wire connected to a driver of a robot by utilizing the fact that stranded wire 1 has a small diameter. Moreover, stranded wire 1 is an extremely thin wire rope (also referred to as a miniature rope) and is employed in a product that uses any of various types of wire ropes. For example, stranded wire 1 is used in applications that demand thinness, such as a catheter (catheter guide wire), a fishing leader, or a motion transmission line of a robot.

Wire diameter φ2 (see FIG. 2) of stranded wire 1 is, for example, 500 μm or smaller, but is not limited thereto. Wire diameter φ2 of stranded wire 1 may be 400 μm or smaller, 300 μm or smaller, 200 μm of smaller, 150 μm or smaller, or 100 μm or smaller.

As illustrated in FIG. 2, stranded wire 1 includes metal stranded wire 10 and resin film 20 that covers the surface of metal stranded wire 10. Stranded wire 1 is a composite wire in which metal stranded wire 10 is covered by resin film 20. Metal stranded wire 10 is an example of a stranded wire body including a plurality of strands that are twisted together.

As illustrated in FIG. 2 and FIG. 3, metal stranded wire 10 is constituted of a plurality of metal wires 11. Metal stranded wire 10 is formed by twisting together the plurality of metal wires 11 as the plurality of strands. In metal stranded wire 10, the respective strands constituting the stranded wire body are metal wires 11. In the example illustrated in FIG. 2 and FIG. 3, metal stranded wire 10 is a seven-core stranded wire in which seven metal wires 11 as seven solid wires are twisted together. The number of metal wires 11 constituting metal stranded wire 10 is not particularly limited, and metal stranded wire 10 may be constituted of any number of metal wires 11 of various types in accordance with the desired strength and wire diameter. For example, metal stranded wire 10 may be a three-core stranded wire including three solid wires that are twisted together, a nineteen-core stranded wire including 19 solid wires that are twisted together, or a thirty-seven-core stranded wire including 37 solid wires that are twisted together. Metal stranded wire 10 is not limited to a metal stranded wire including solid wires that are twisted together, and may be formed by being further entwined with a metal stranded wire including solid wires that are twisted together. Although all metal wires 11 have the same wire diameter in the illustrated example, a combination of metal wires 11 having different wire diameters may be used in metal stranded wire 10.

Each metal wire 11 is a tungsten wire containing tungsten (W) as a principal component. The term “principal component” implies that the content percentage of an element or material is higher than 50 mass %. For example, the content percentage of tungsten contained in each metal wire 11 is 90 mass % or higher. The content percentage of tungsten contained in each metal wire 11 may be 95 mass % or higher, 99 mass % or higher, 99.9 mass % or higher, or 99.99 mass % or higher. Although each metal wire 11 is, for example, a so-called pure tungsten wire, an inevitable impurity that cannot be prevented from being mixed therein during the manufacturing process may be contained therein. Metal stranded wire 10 using metal wires 11 containing tungsten as the principal component can be increased in strength, but is difficult to return to its original shape when bent due to the existence of tungsten crystals extending long in the axial direction of metal wires 11. For example, with metal stranded wire 10 alone, kinking tends to occur more, as compared with a stranded wire using stainless steel, nylon, or polyethylene strands. In contrast, in stranded wire 1, metal stranded wire 10 is covered by resin film 20 having a predetermined thickness, so that stranded wire 1 can suppress kinking while also being increased in strength.

Each metal wire 11 may be a tungsten alloy wire composed of a tungsten alloy as an alloy of tungsten and at least one kind of metal other than tungsten. The metal other than tungsten is, for example, rhenium (Re). The content percentage of rhenium contained in each metal wire 11 composed of a rhenium-tungsten alloy (ReW) is, for example, at least 0.1 mass % and at most 10 mass %, but is not limited thereto. For example, the content percentage of rhenium contained in each metal wire 11 may be 1 mass % or higher, 3 mass % or higher, or 5 mass % or higher.

When the content percentage of rhenium is high, the tensile strength of metal wires 11 can be increased. On the other hand, when the content percentage of rhenium is too high, it is difficult to achieve diameter reduction while still maintaining the high tensile strength of metal wires 11. In detail, wire breakage tends to occur easily, thus making wire drawing difficult over an extended length. By reducing the content percentage of rhenium and setting the content percentage of tungsten to 90 mass % or higher, the processability of metal wires 11 can be enhanced. Moreover, reducing the content percentage of rhenium, which is rare and expensive, enables mass production of inexpensive long metal wires 11.

The metal used together with tungsten in the alloy may be osmium (Os), ruthenium (Ru), or iridium (Ir). The content percentage of osmium, ruthenium, or iridium is similar to, for example, the content percentage of rhenium. In these cases, an advantage similar to the case of the rhenium-tungsten alloy can be achieved. Each metal wire 11 may be composed of an alloy of tungsten and at least two kinds of metals other than tungsten.

Each metal wire 11 may be a doped tungsten wire doped with potassium (K). The potassium that has been doped exists in grain boundaries of tungsten crystals. The content percentage of potassium (K) contained in each metal wire 11 is, for example, 0.010 mass % or lower. Even with a potassium-doped tungsten wire, a metal wire having a tensile strength higher than the normal tensile strength of a piano wire can be realized. In addition to a potassium oxide, a similar effect can be achieved with an oxide of a rare earth metal, such as cerium or lanthanum, and an oxide of another material. Each metal wire 11 may contain a rare earth element.

The wire diameter of each metal wire 11 is, for example, 150 μm or smaller, but is not limited thereto. The wire diameter of each metal wire 11 may be 100 μm or smaller, 80 μm or smaller, 60 μm or smaller, 45 μm or smaller, 30 μm or smaller, 25 μm or smaller, 20 μm or smaller, 15 μm or smaller, 13 μm or smaller, 11 μm or smaller, 10 μm or smaller, 9 μm or smaller, 8 μm or smaller, or 7 μm or smaller. For example, ultrathin metal wires 11 each having a wire diameter of about 5 μm can also be realized.

Metal wires 11 with a reduced wire diameter enable reduced wire diameter φ1 of metal stranded wire 10 and reduced wire diameter φ2 of stranded wire 1, and are effectively applicable to a thin wire rope.

The tensile strength of metal wires 11 is, for example, 4500 MPa, but is not limited thereto. The tensile strength of metal wires 11 may be 4800 MPa or higher or 5000 MPa or higher. Furthermore, for example, metal wires 11 with a high tensile strength of 5500 MPa or higher can also be realized.

Metal stranded wire 10 increases in tensile strength with increasing tensile strength of metal wires 11, and is thus advantageous for increasing the strength of stranded wire 1. As a result, diameter reduction can be achieved while strength is maintained, so that both increased strength and reduced diameter of stranded wire 1 can be readily achieved. In particular, with high-strength metal wires 11 with a tensile strength of 4500 MPa or higher, stranded wire 1 can be effectively reduced in diameter. On the other hand, since the tungsten crystals in metal wires 11 become longer in the axial direction of metal wires 11 with increasing tensile strength of metal wires 11, it becomes more difficult for metal wires 11 to return to the original shape when bent, thus causing kinking to occur easily. In this respect, in stranded wire 1, metal stranded wire 10 is covered by resin film 20 having the predetermined thickness, so that, for example, kinking can be suppressed while both increased strength and reduced diameter are achieved. As the tensile strength of metal wires 11 increases, kinking is effectively suppressed by resin film 20.

The tensile strength of metal wires 11 is obtained by dividing the breaking strength (stress at the time of breakage) of metal wires 11 by the cross-sectional area of metal wires 11. The tensile strength is measured based on, for example, a tensile test according to Japanese Industrial Standards (JIS H 4460 8).

The tensile strength of metal stranded wire 10 varies depending on metal wires 11 and the number and the twisting method of metal wires 11 in metal stranded wire 10. The tensile strength of metal stranded wire 10 is obtained by dividing the breaking strength of metal stranded wire 10 by an area of a circle having wire diameter φ1 of metal stranded wire 10 as the diameter. Specifically, the tensile strength of metal stranded wire 10 is calculated assuming that it is a solid wire with wire diameter φ1. Therefore, when a fill factor (a ratio of the total cross-sectional area of metal wires 11 to the area of the circle having wire diameter φ1 as the diameter) of metal wires 11 in metal stranded wire 10 decreases, the tensile strength of metal stranded wire 10 also decreases.

Furthermore, for example, the breaking strength of metal stranded wire 10 decreases by about 5% to 15% from the total breaking strength of metal wires 11 constituting metal stranded wire 10. If metal stranded wire 10 is a seven-core stranded wire, as illustrated in FIG. 2 and FIG. 3, for example, the breaking strength of metal stranded wire 10 decreases by about 5% from the total breaking strength of metal wires 11 constituting metal stranded wire 10.

If metal stranded wire 10 is a seven-core stranded wire, the tensile strength of metal stranded wire 10 is, for example, 3200 MPa or higher. In this case, by using metal wires 11 having a tensile strength of 4500 MPa or higher, metal stranded wire 10 with a tensile strength of 3200 MPa or higher can be realized. Accordingly, when the tensile strength of metal stranded wire 10A is high, since kinking tends to occur easily due to the use of metal wires 11 having a high tensile strength, the suppression of kinking by resin film 20 is more effective. Moreover, further diameter reduction can be achieved while the strength of stranded wire 1 is maintained.

Resin film 20 is a film containing resin as a principal component. The content percentage of the resin contained in resin film 20 is, for example, 80 mass % or higher. The content percentage of the resin contained in resin film 20 may be 90 mass % or higher or 99 mass % or higher. Resin film 20 may contain any of various kinds of resin additives and/or inevitable impurities that cannot be prevented from being mixed therein during the manufacturing process. Resin film 20 having predetermined thickness T covers metal stranded wire 10 to alleviate stress when metal stranded wire 10 is bent, thereby suppressing kinking of stranded wire 1.

The resin is not particularly limited so long as the material used can adhere to and cover the surface of metal stranded wire 10. Examples of the resin include acrylic resin, polyester resin, epoxy resin, urethane resin, fluorine resin, and nylon resin.

In this embodiment, resin film 20 is provided in the circumferential direction of the outer surface of metal stranded wire 10 as well as the axial direction thereof. For example, resin film 20 is provided over the entire outer surface of metal stranded wire 10. Resin film 20 is in contact with the outer surface of metal stranded wire 10. Gaps surrounded by metal wires 11 may be or does not have to be provided with resin film 20.

In the example illustrated in FIG. 2, the cross-sectional outer peripheral shape of resin film 20 (i.e., the cross-sectional shape of stranded wire 1) is circular. On the outer periphery of resin film 20, resin film 20 may be provided with protrusions and recesses in conformity with protrusions and recesses on the outer periphery of metal stranded wire 10. The cross-sectional outer peripheral shape of resin film 20 may be elliptical.

[Relationship between Wire Diameter of Metal Stranded Wire and Thickness of Resin Film]

Next, the relationship between wire diameter φ1 of metal stranded wire 10 and thickness T of resin film 20 will be described with reference to FIG. 2.

In this embodiment, the ratio of thickness T of resin film 20 to wire diameter φ1 of metal stranded wire 10 is 8% or higher. Accordingly, resin film 20 can effectively alleviate bending stress applied to metal stranded wire 10, thereby suppressing kinking of stranded wire 1. From the standpoint of further suppressing kinking of stranded wire 1, the ratio of thickness T of resin film 20 to wire diameter φ1 of metal stranded wire 10 may be 15% or higher. From the standpoint of achieving both diameter reduction and kink suppression, the ratio of thickness T of resin film 20 to wire diameter φ1 of metal stranded wire 10 may be 40% or lower or 27% or lower. Since kinking tends to occur easily as the flexibility of metal stranded wire 10 decreases with increasing wire diameter φ1 of metal stranded wire 10, the ratio of thickness T of resin film 20 to wire diameter 1 of metal stranded wire 10 is more important for suppressing kinking than an absolute value of thickness T of resin film 20. If wire diameter φ1 of metal stranded wire 10 is large, thickness T of resin film 20 may be increased accordingly to effectively suppress kinking.

Wire diameter φ1 of metal stranded wire 10 is the diameter of a circumscribed circle of the plurality of metal wires 11 constituting metal stranded wire 10 in the cross section of metal stranded wire 10. In the case of the seven-core stranded wire, as illustrated in FIG. 2, wire diameter φ1 is the length of metal stranded wire 10 in the radial direction at a position where three metal wires 11 are arranged in the radial direction. For example, the length of metal stranded wire 10 in the radial direction at the position where three metal wires 11 are arranged in the radial direction (i.e., the diameter of the circumscribed circle of metal stranded wire 10) is measured by using a caliper or the like at a predetermined number (e.g., two or more) of arbitrary locations, and wire diameter φ1 is calculated by averaging out the measured values. Thickness T of resin film 20 is the shortest distance from the outer periphery of metal stranded wire 10 to the outer periphery of resin film 20. As in the example illustrated in FIG. 2, when resin film 20 is provided evenly around the center of metal wires 11, thickness T of resin film 20 can also be calculated by dividing a value, which is obtained by subtracting wire diameter φ1 of metal stranded wire 10 from wire diameter φ2 of stranded wire 1, by 2. Specifically, thickness T=(wire diameter φ2−wire diameter φ1)/2. Therefore, thickness T of resin film 20 can be calculated by measuring wire diameter φ1 of metal stranded wire 10, in a state where it does not include resin film 20, and wire diameter φ2 of stranded wire 1. Furthermore, a cross section orthogonal to the axial direction of stranded wire 1 may be formed, and wire diameter φ1 of metal stranded wire 10, thickness T of resin film 20, and wire diameter φ2 of stranded wire 1 may be measured from a microscope photograph or the like of the cross section.

### [Manufacturing Method]

Next, a manufacturing method of stranded wire 1 according to this embodiment will be described with reference to FIG. 4. FIG. 4 is a flowchart illustrating the manufacturing method of stranded wire 1 according to this embodiment.

First, metal wires 11 each having a predetermined wire diameter and tensile strength and containing tungsten as a principal component are prepared (S10).

For example, a tungsten ingot is first prepared. In detail, the tungsten ingot is formed by pressing and sintering tungsten powder. In this case, if tungsten alloy wires are to be manufactured, a mixture of tungsten powder and metal powder for the alloy is pressed and sintered. In the case of doped tungsten wires, doped tungsten powder doped with potassium or the like is pressed and sintered.

Subsequently, the prepared ingot is repeatedly swaged and heated, so as to be formed into a wire having a predetermined wire diameter (e.g., about 3 mm). An oxide layer is formed on the surface of the wire by heating, and the oxide layer is impregnated with a lubricant composed of, for example, carbon, so that breakage occurring during wire drawing (drawing process) can be suppressed.

Then, wire drawing (thinning) is performed by using a wire drawing die, such as a single-crystal diamond die. The wire drawing is performed while heating is performed. The wire drawing is repeatedly performed. In the repetition of wire drawing, adjustments are performed to gradually reduce the hole diameter of the die and the heating temperature. Accordingly, metal wires 11 with high tensile strength are manufactured.

Finally, an adjustment to a desired wire diameter is performed by electrolytic polishing. For example, in a state where each metal wire 11 and a counter electrode are immersed in an electrolytic solution, such as a sodium hydroxide solution, electrolytic polishing is performed by applying voltage between metal wire 11 and the counter electrode. The electrolytic polishing may be omitted.

Subsequently, metal stranded wire 10 is formed by twisting prepared metal wires 11 together (S20). Metal stranded wire 10 is formed by twisting together a plurality of metal wires 11 as strands. For example, if metal stranded wire 10 is a seven-core stranded wire, metal stranded wire 10 is formed by setting one of metal wires 11 as a central strand located at the center of metal stranded wire 10, and winding remaining six metal wires 11 wound around the central strand. The winding direction in this case is not particularly limited, and may be S-twisting or Z-twisting.

Then, resin film 20 is formed on the surface of formed metal stranded wire 10 (S30). Consequently, stranded wire 1 is obtained.

Resin film 20 is formed in accordance with, for example, an electrodeposition method. Specifically, resin film 20 may be an electrodeposited film. The electrodeposition method first involves immersing metal stranded wire 10 and a counter electrode in an electrolytic solution, in which an ionized electrodeposition resin raw material serving as a raw material for resin film 20 is dissolved or dispersed, and causing the resin raw material to adhere to the surface of metal stranded wire 10 by applying voltage between metal stranded wire 10 and the counter electrode. Then, metal stranded wire 10 having the resin raw material adhered thereto is heated so that the resin raw material is cured, whereby resin film 20 is formed on the surface of metal stranded wire 10. Thickness T of resin film 20 is adjustable in accordance with the voltage application time and the temperature of the electrolytic solution. By using the electrodeposition method, uniform resin film 20 adhered to the surface of metal stranded wire 10 can be readily formed, thereby effectively suppressing kinking of stranded wire 1. Furthermore, since the electrodeposition method does not involve any application of stress to the resin during the forming process, uniform resin film 20 can be readily formed. Moreover, the electrodeposition method is advantageous for reducing the diameter of stranded wire 1 since thin resin film 20 can be readily formed. The resin used is, for example, acrylic resin, epoxy resin, or urethane resin.

The method for forming resin film 20 on the surface of metal stranded wire 10 is not particularly limited, and another formation method, such as an extrusion method (also called a drawing process), may be used for forming resin film 20. The extrusion method involves coating the surface of metal stranded wire 10 with resin and subsequently inserting metal stranded wire 10 coated with the resin through a hole of, for example, a die, thereby processing resin film 20. In this case, the diameter of the hole is selected so that resin film 20 has desired thickness T. In the extrusion method, the resin used is, for example, fluorine resin, polyester resin, or nylon resin.

### [Variations]

Next, stranded wires according to variations of the embodiment will be described. In the following description of the variations, the focus will be on differences from the embodiment, and explanations of common points will be omitted or simplified.

### (1) Variation 1

Stranded wire 1 described above uses metal stranded wire 10 including solid wires that are twisted together, but is not limited thereto, and may use a metal stranded wire further including metal stranded wires that are twisted together.

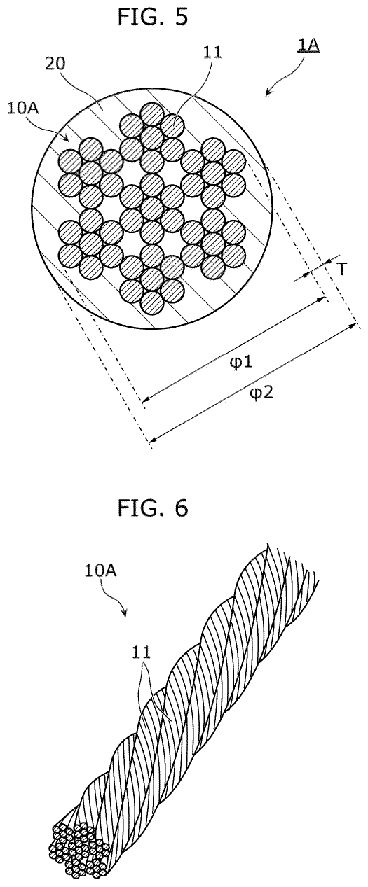

FIG. 5 is a schematic cross-sectional view illustrating stranded wire 1A according to Variation 1 of the embodiment. FIG. 6 is a schematic partial view illustrating metal stranded wire 10A used in stranded wire 1A according to Variation 1 of the embodiment. The cross section of stranded wire 1A illustrated in FIG. 5 is taken in a direction orthogonal to an axial direction (direction in which stranded wire 1A extends) of stranded wire 1A.

As illustrated in FIG. 5, stranded wire 1A has a configuration in which metal stranded wire 10 of stranded wire 1 has been replaced by metal stranded wire 10A. Metal stranded wire 10A is an example of a stranded wire body including a plurality of strands that are twisted together.

As illustrated in FIG. 5 and FIG. 6, metal stranded wire 10A is formed by further twisting together a plurality of metal stranded wires each including a plurality of metal wires 11 that are twisted together. In metal stranded wire 10A, the respective strands constituting the stranded wire body are metal wires 11. In the example illustrated in FIG. 5 and FIG. 6, metal stranded wire 10A is a seven-by-seven-core stranded wire including seven seven-core stranded wires that are twisted together, and is formed by twisting together seven metal stranded wires 10 illustrated in FIG. 2 and FIG. 3. For example, the seven-by-seven-core stranded wire is formed by winding six seven-core stranded wires around one remaining seven-core stranded wire. The configuration of metal wires 11 in metal stranded wire 10A is not particularly limited, and metal stranded wire 10A may be, for example, a seven-by-nineteen-core stranded wire (including seven nineteen-core stranded wires that are twisted together), a six-by-seven-core stranded wire (including six seven-core stranded wires that are twisted together), or a three-by-seven-core stranded wire (including three seven-core stranded wires that are twisted together). The number of metal wires 11 in the metal stranded wires to be twisted together does not have to be all the same, and metal stranded wire 10A may include metal stranded wires including different numbers of metal wires 11 that are twisted together.

If metal stranded wire 10A is a seven-by-seven-core stranded wire, as illustrated in FIG. 5 and FIG. 6, for example, the breaking strength of metal stranded wire 10A decreases by about 15% from the total breaking strength of metal wires 11 constituting metal stranded wire 10.

If metal stranded wire 10A is a seven-by-seven-core stranded wire, the tensile strength of metal stranded wire 10A is, for example, 2300 MPa or higher. In this case, by using metal wires 11 having a tensile strength of 4500 MPa or higher, metal stranded wire 10A with a tensile strength of 2300 MPa or higher can be realized. Accordingly, when the tensile strength of metal stranded wire 10A is high, since kinking tends to occur easily due to the use of metal wires 11 having a high tensile strength, the suppression of kinking by resin film 20 is more effective. Moreover, further diameter reduction can be achieved while the strength of stranded wire 1A is maintained.

In stranded wire 1A, the ratio of thickness T of resin film 20 to wire diameter φ1 of metal stranded wire 10A is 8% or higher. Accordingly, resin film 20 can effectively alleviate bending stress applied to metal stranded wire 10A, thereby suppressing kinking of stranded wire 1A. From the standpoint of further suppressing kinking of stranded wire 1A, the ratio of thickness T of resin film 20 to wire diameter φ1 of metal stranded wire 10A may be 15% or higher. From the standpoint of achieving both diameter reduction and kink suppression, the ratio of thickness T of resin film 20 to wire diameter φ1 of metal stranded wire 10A may be 40% or lower or 27% or lower. The measurement methods for wire diameter φ1 of metal stranded wire 10A, thickness T of resin film 20, and wire diameter φ2 of stranded wire 1A are similar to the measurement methods with respect to stranded wire 1 described above.

### (2) Variation 2

Stranded wire 1 includes metal wires 11 wound around remaining metal wire 11 serving as the central strand at the center, but is not limited thereto, and the metal stranded wire may include a hollow section.

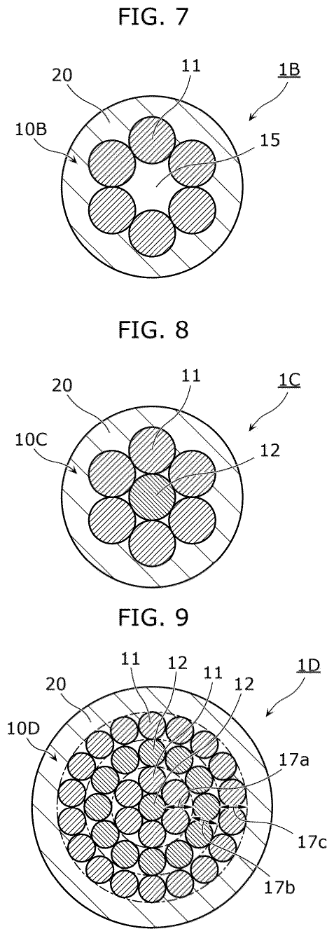

FIG. 7 is a schematic cross-sectional view illustrating stranded wire 1B according to Variation 2 of the embodiment. The cross section of stranded wire 1B illustrated in FIG. 7 is taken in a direction orthogonal to an axial direction (direction in which stranded wire 1B extends) of stranded wire 1B.

As illustrated in FIG. 7, stranded wire 1B has a configuration in which metal stranded wire 10 of stranded wire 1 is replaced by metal stranded wire 10B. Metal stranded wire 10B is an example of a stranded wire body including a plurality of strands that are twisted together. Metal stranded wire 10B has a configuration in which metal wire 11 serving as the central strand has been removed from metal stranded wire 10.

Metal stranded wire 10B includes hollow section 15 serving as a cavity located at the center of metal stranded wire 10B in the radial direction, and also includes a plurality of metal wires 11 surrounding hollow section 15 in the radial direction. Metal stranded wire 10B includes the plurality of metal wires 11 that are twisted together in such a manner as to form hollow section 15. In metal stranded wire 10B, the respective strands constituting the stranded wire body are metal wires 11. The number of metal wires 11 constituting metal stranded wire 10B is not particularly limited, and metal stranded wire 10B may be constituted of any number of metal wires 11 of various types in accordance with the desired strength and wire diameter.

In stranded wire 1B, metal stranded wire 10B includes hollow section 15, so that the flexibility of stranded wire 1B can be further enhanced. Moreover, with hollow section 15, stranded wire 1B can be reduced in weight and cost. Similar to stranded wire 1 and the like, the ratio of the thickness of resin film 20 to the wire diameter of metal stranded wire 10B is 8% or higher, so that kinking can be suppressed.

### (3) Variation 3

Although metal stranded wire 10 constituted of the plurality of metal wires 11 is used as a stranded wire body in stranded wire 1 described above, the stranded wire body may include a strand other than metal wires 11.

FIG. 8 is a schematic cross-sectional view illustrating stranded wire 1C according to Variation 3 of the embodiment. The cross section of stranded wire 1C illustrated in FIG. 8 is taken in a direction orthogonal to an axial direction (direction in which stranded wire 1C extends) of stranded wire 1C.

As illustrated in FIG. 8, stranded wire 1C has a configuration in which metal stranded wire 10 of stranded wire 1 has been replaced by stranded wire body 10C. Stranded wire body 10C has a configuration in which metal wire 11 serving as the central strand of metal stranded wire 10 has been changed to resin fiber 12.

A plurality of strands constituting stranded wire body 10C include, as strands, resin fiber 12 serving as the central strand located at the center of stranded wire body 10C in the radial direction and a plurality of metal wires 11 surrounding resin fiber 12 in the radial direction. The number of metal wires 11 and the number of resin fibers 12 constituting stranded wire body 10C are not particularly limited, and stranded wire body 10C may be constituted of any number of metal wires 11 and resin fibers 12 of various types in accordance with the desired strength and wire diameter. Furthermore, stranded wire body 10C may include resin fiber 12 as a strand other than the central strand, and in this case, the central strand may be metal wire 11.

Examples of the resin used for forming resin fiber 12 include, for example, polyester resin, polyethylene resin, polypropylene resin, acrylic resin, aramid resin, and nylon resin.

In stranded wire 1C, stranded wire body 10C includes resin fiber 12 as the central strand, so that the cut resistance can be enhanced. Similar to stranded wire 1 and the like, the ratio of the thickness of resin film 20 to the wire diameter of stranded wire body 10C is 8% or higher, so that kinking can be suppressed.

### (4) Variation 4

In metal stranded wire 10 of stranded wire 1 described above and stranded wire body 10C of stranded wire 1C, it can also be regarded that a strand layer is formed by metal wires 11 surrounding the central strand. Metal stranded wire 10 and stranded wire body 10C each include a single strand layer, but may alternatively include a plurality of strand layers.

FIG. 9 is a schematic cross-sectional view illustrating stranded wire 1D according to Variation 4 of the embodiment. The cross section of stranded wire 1D illustrated in FIG. 9 is taken in a direction orthogonal to an axial direction (direction in which stranded wire 1D extends) of stranded wire 1D.

As illustrated in FIG. 9, stranded wire 1D has a configuration in which stranded wire body 10C of stranded wire 1C has been replaced by stranded wire body 10D. Stranded wire body 10D has a configuration in which a plurality of strand layers are formed by further winding a plurality of strands around stranded wire body 10C.

Stranded wire body 10D includes resin fiber 12 serving as the central strand constituted of one strand of the plurality of strands, and also includes a plurality of strand layers 17a, 17b, and 17c concentrically surrounding resin fiber 12 serving as the central strand and each constituted of at least two strands of the plurality of strands. Stranded wire body 10D is formed by winding the at least two strands constituting each of the plurality of strand layers 17a, 17b, and 17c sequentially around resin fiber 12 serving as the central strand. The plurality of strand layers 17a, 17b, and 17c are arranged in this order outward from the center in the radial direction.

Stranded wire body 10D includes, as a plurality of strands, a plurality of metal wires 11 and a plurality of resin fibers 12. In the example illustrated in FIG. 9, strand layers 17a and 17c are metal strand layers each constituted of a plurality of metal wires 11. Strand layer 17b is a resin strand layer constituted of a plurality of resin fibers 12. In stranded wire body 10D, outermost strand layer 17c is a metal strand layer.

In stranded wire 1D, stranded wire body 10D includes strand layers 17a and 17c each including metal wires 11 and also includes strand layer 17b including resin fibers 12, so that the cut resistance can be further enhanced. Similar to stranded wire 1 and the like, the ratio of the thickness of resin film 20 to the wire diameter of stranded wire body 10D is 8% or higher, so that kinking can be suppressed.

In the example illustrated in FIG. 9, each of the plurality of strand layers 17a, 17b, and 17c is constituted entirely of strands of the same type (metal wires 11 or resin fibers 12), but may be a mixed strand layer using a mixture of metal wires 11 and resin fibers 12. Moreover, the central strand may be metal wire 11. Furthermore, the number of metal wires 11 and the number of resin fibers 12 constituting stranded wire body 10D are not particularly limited, and stranded wire body 10D may be constituted of any number of metal wires 11 and resin fibers 12 of various types in accordance with the desired strength and wire diameter.

### [Kink Resistance Test]

Next, a kink resistance test using stranded wire 1 will be described.

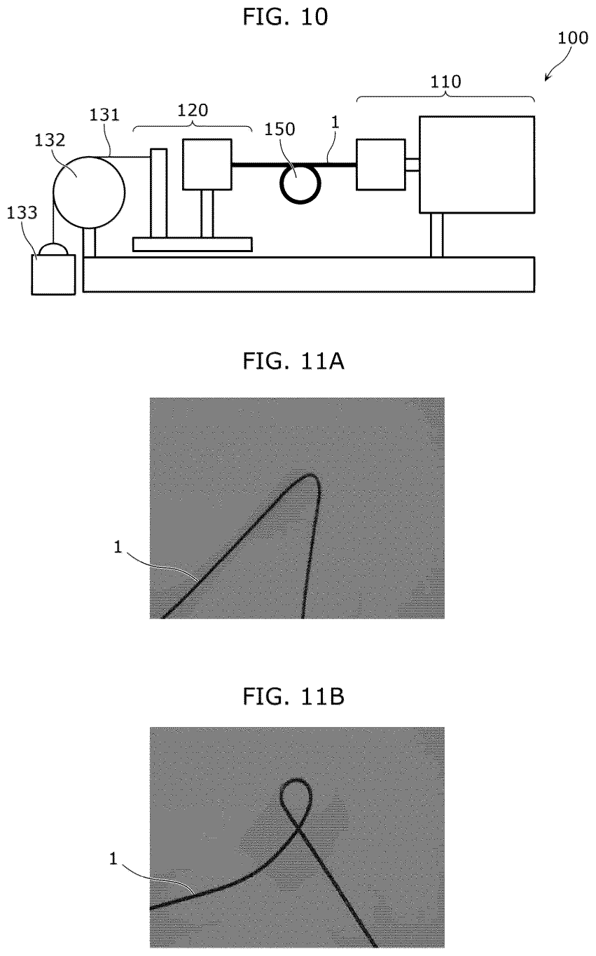

FIG. 10 is a schematic view illustrating an overview of a testing device employed in a kink resistance test using stranded wire 1 according to the embodiment.

Testing device 100 illustrated in FIG. 10 is a device for performing a kink resistance test. Testing device 100 includes stationary unit 110, movable unit 120, wire 131, roller 132, weight 133, and mandrel 150. Stationary unit 110 and movable unit 120 are arranged apart from each other in a predetermined direction. Stationary unit 110 is positionally fixed, whereas movable unit 120 is slidable in the predetermined direction. Movable unit 120 includes weight 133 attached thereto via wire 131 supported by roller 132, so as to receive a load in a direction extending away from stationary unit 110. In the kink resistance test, stranded wire 1 has one end connected to stationary unit 110 and the other end connected to movable unit 120 in a state where stranded wire 1 is wound once around mandrel 150, which is a cylindrical metal rod. Accordingly, stranded wire 1 receives a load equivalent to the weight of weight 133.

The kink resistance test involves preparing mandrels 150 having diameters of 1.5 mm, 1.25 mm, 1.15 mm, 1.0 mm, and 0.9 mm, and checking the diameter of mandrel 150 that has caused stranded wire 1 to kink. Since kinking tends to occur more as the diameter of mandrel 150 decreases, the diameter of mandrel 150 is gradually decreased in the above order, and the diameter of mandrel 150 that has caused kinking to occur first is set as the diameter of mandrel 150 at the time of kink occurrence. The weight of prepared weight 133 is 100 g, and the occurrence of kinking is checked under a condition where a load of 100 gf is applied to stranded wire 1 for five seconds. FIG. 11A illustrates a microscope photograph when stranded wire 1 is not kinked. In contrast, FIG. 11B illustrates a microscope photograph when stranded wire 1 is kinked. As illustrated in FIG. 11A and FIG. 11B, it is determined whether or not kinking has occurred based on whether or not a ring shape is observed on stranded wire 1, after being released from the load, due to maintaining the wound shape around mandrel 150.

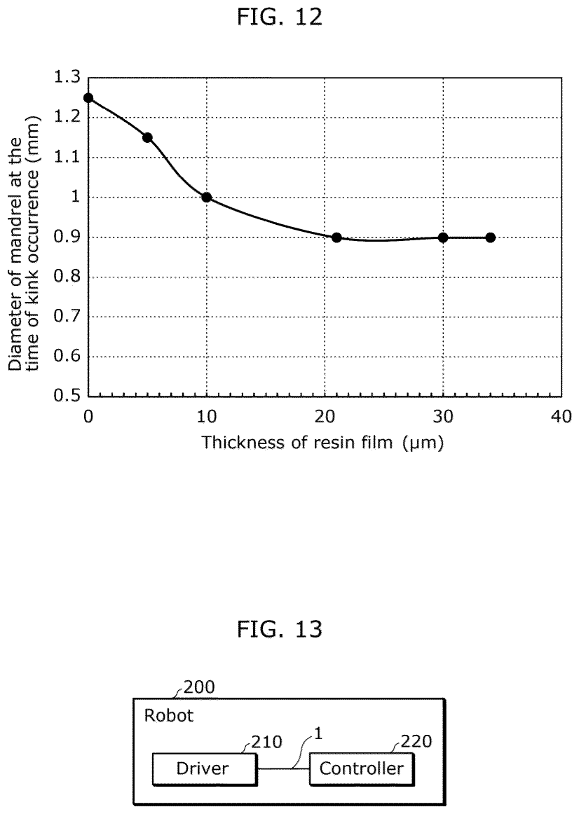

Next, results of the kink resistance test performed on actually-fabricated sample products of stranded wire 1 will be described with reference to Table 1 and FIG. 12.

The present inventors have fabricated six kinds of sample products including resin films 20 with different thicknesses T and performed the above-described kink resistance test on each product. The six kinds of sample products include a sample product with thickness T=0 μm, that is, a sample product not including resin film 20.

Thickness T of resin film 20 in each sample product and the diameter of mandrel 150 at the time of kink occurrence are as shown in Table 1. Each sample product is fabricated by forming resin film 20 composed of acrylic resin by electrodeposition on the surface of metal stranded wire 10 that is obtained by twisting together seven metal wires 11 each having a wire diameter of 42 μm and a tensile strength of 4800 MPa. Wire diameter φ1 of metal stranded wire 10 is 126 μm, and the tensile strength of metal stranded wire 10 is 3500 MPa.

In addition to thickness T of resin film 20 and the diameter of mandrel 150 at the time of kink occurrence, Table 1 indicated below also shows the ratio of thickness T of resin film 20 to wire diameter φ1 of metal stranded wire 10.

TABLE 1

| Thickness T | Thickness T/ | Mandrel Diameter at the Time of |
|---|---|---|
| [μm] | Wire Diameter φ1 | Kink Occurrence [mm] |
| 0 | 0% | 1.25 |
| 5 | 4% | 1.15 |
| 10 | 8% | 1.0 |
| 21 | 17% | 0.9 |
| 30 | 24% | 0.9 |
| 34 | 27% | 0.9 |

FIG. 12 is a graph illustrating the relationship between thickness T of resin film 20 and the diameter of mandrel 150 at the time of kink occurrence in the kink resistance test. In FIG. 12, the abscissa axis denotes thickness T (unit: μm) of resin film 20, whereas the ordinate axis denotes the diameter (unit: mm) of mandrel 150 at the time of kink occurrence. FIG. 12 is a graphical representation of Table 1.

As shown in Table 1 and FIG. 12, when thickness T of resin film 20 is 0 μm (i.e., when resin film 20 is not formed), the diameter of mandrel 150 at the time of kink occurrence is 1.25 mm, and kinking tends to occur easily. In contrast, when resin film 20 is formed, the diameter of mandrel 150 at the time of kink occurrence decreases as thickness T of resin film 20 increases. In particular, when thickness T of resin film 20 is 10 μm or larger (when thickness T/wire diameter φ1 is 8% or higher), the diameter of mandrel 150 at the time of kink occurrence is 1.0 mm or smaller, so that a significant suppression effect against kink occurrence can be confirmed. When thickness T of resin film 20 is 21 μm or larger (when thickness T/wire diameter φ1 is 17% or higher), there is no change in the diameter of mandrel 150 at the time of kink occurrence, thus conceivably indicating that a sufficient suppression effect against kink occurrence can be obtained so long as thickness T of resin film 20 is a predetermined thickness or larger.

Accordingly, when the ratio of thickness T of resin film 20 to wire diameter φ1 of metal stranded wire 10 is 8% or higher, it is apparent that kinking of stranded wire 1 using high-strength metal wires 11 can be effectively suppressed.

### [Effects, Etc.]

As described above, stranded wire 1 according to this embodiment includes metal stranded wire 10 constituted of the plurality of metal wires 11 each containing tungsten as a principal component, and also includes resin film 20 that covers the surface of metal stranded wire 10. The ratio of thickness T of resin film 20 to wire diameter φ1 of metal stranded wire 10 is 8% or higher.

Accordingly, resin film 20 having thickness T with the aforementioned ratio covers the surface of metal stranded wire 10, so that resin film 20 can effectively alleviate bending stress applied to the metal stranded wire 10, thereby suppressing kinking of stranded wire 1. Furthermore, with the use of metal stranded wire 10 constituted of the plurality of metal wires 11 having high strength due to containing tungsten as a principal component, both increased strength and reduced diameter can be achieved.

Moreover, for example, the tensile strength of metal stranded wire 10 may be 3200 MPa or higher.

Accordingly, when the tensile strength of metal stranded wire 10A is high, since kinking tends to occur easily due to the use of metal wires 11 having a high tensile strength, the suppression of kinking by resin film 20 is more effective.

Furthermore, for example, resin film 20 may be an electrodeposited film.

Accordingly, uniform resin film 20 can be readily formed on the surface of metal stranded wire 10, thereby effectively suppressing kinking of stranded wire 1.

Accordingly, stranded wire 1 is resistant to kinking while also being able to have a small diameter and high strength, so that the performance of a product using stranded wire 1 can be enhanced. Stranded wire 1 can be reduced in diameter while having a strength higher than or equivalent to that of a stranded wire using stainless steel, nylon, or polyethylene strands. Thus, for example, when stranded wire 1 is used as an electrical wire, a product using the electrical wire can be reduced in size. In particular, the use of stranded wire 1 as an electrical wire connected to a driver of a robot enables size reduction of the robot. Moreover, for example, when stranded wire 1 is used in a catheter, the load on a patient can be reduced. Furthermore, for example, the use of stranded wire 1 in a fishing leader makes the fishing leader less recognizable from fish. Moreover, for example, when stranded wire 1 is used in a motion transmission line of a robot, stranded wire 1 can also be applied to a robot using a small pulley, thus enabling size reduction of the robot as well as control of a delicate force. Even with the use of stranded wire 1 in these applications, stranded wire 1 is resistant to kinking and thus has high durability and a lower possibility of an operational error or the like.

### Usage Example

Next, an example of a product using stranded wire 1 according to the above embodiment will be described.

FIG. 13 is a diagram illustrating robot 200 as an example of a product using stranded wire 1 according to this embodiment.

As illustrated in FIG. 13, robot 200 includes driver 210, controller 220, and stranded wire 1 as an electrical wire connected to driver 210. Robot 200 is, for example, a factory automation robot. Robot 200 may be a robot other than that for factory automation, such as an autonomous mobile robot.

In robot 200, stranded wire 1 is used as an electrical wire connected to driver 210. Driver 210 includes a driving mechanism including a motor, an actuator, or the like and operates based on a control signal from controller 220. The control signal is transmitted from controller 220 to driver 210 via stranded wire 1 serving as an electrical wire that connects driver 210 and controller 220 to each other. Specifically, stranded wire 1 is used as an electrical wire for transmitting a signal.

Controller 220 controls the operation of driver 210. Controller 220 is, for example, a control device including a processor or a microcomputer.

As mentioned above, stranded wire 1 can be reduced in diameter while maintaining its strength, and kinking thereof is also suppressed. Therefore, the use of stranded wire 1 as the electrical wire connected to driver 210 in robot 200 enables size reduction of robot 200, and also reduces the possibility of kinking even when stress is applied to stranded wire 1 in accordance with the operation of driver 210, thereby improving the operational stability of robot 200.

Stranded wire 1 connected to driver 210 may be used as an electrical wire for supplying driving electric power to driver 210. Similar to the above, this also enables size reduction of robot 200 and improved operational stability thereof. When stranded wire 1 is used as an electrical wire for supplying electric power, stranded wire 1 may be connected to controller 220, as illustrated in FIG. 13, so as to supply the electric power to driver 210 via controller 220, or stranded wire 1 serving as an electrical wire that connects another power supply circuit or an external power source (not shown) to driver 210 may be included in robot 200.

Although stranded wire 1 is used as an electrical wire included in a robot in the above description, stranded wire 1A, 1B, 1C, or 1D according to each variation described above may be used as the electrical wire in place of stranded wire 1. Any of stranded wires 1, 1A, 1B, 1C, and 1D may be used as an electrical wire included in a product, such as a household appliance, an analysis device, or production equipment, other than a robot. Accordingly, a product using any of stranded wires 1, 1A, 1B, 1C, and 1D can be reduced in size and can achieve improved operational stability.

### (Miscellaneous)

Although the stranded wire according to the present invention has been described above based on the above embodiment, the present invention is not to be limited to the above embodiment.

The present invention encompasses modes conceivable by a skilled person and obtained by variously modifying each of the embodiment and the variations of the embodiment, as well as modes achieved by arbitrarily combining the components and functions in each of the embodiment and the variations of the embodiment, so long as the modes do not depart from the scope of the present invention.

Examples of the stranded wire and the robot according to the present invention described based on the above embodiment are indicated below. The stranded wire and the robot according to the present invention are not to be limited to the following examples.

For example, a stranded wire according to a first aspect of the present invention includes: a stranded wire body including a plurality of strands that are twisted together, the plurality of strands including a metal wire containing tungsten as a principal component; and a resin film that covers a surface of the stranded wire body. A ratio of a thickness of the resin film to a wire diameter of the stranded wire body is 8% or higher.

Furthermore, for example, a stranded wire according to a second aspect of the present invention is the stranded wire according to the first aspect in which, the stranded wire body is a metal stranded wire including the plurality of strands each of which is the metal wire.

Furthermore, for example, a stranded wire according to a third aspect of the present invention is the stranded wire according to the first or second aspect in which, the stranded wire body includes a hollow section located at a center of the stranded wire body, and the plurality of strands surround the hollow section.

Furthermore, for example, a stranded wire according to a fourth aspect of the present invention is the stranded wire according to the first aspect in which, the plurality of strands include a resin fiber located at a center of the stranded wire body and a plurality of metal wires surrounding the resin fiber, the plurality of metal wires each being the metal wire.

Furthermore, for example, a stranded wire according to a fifth aspect of the present invention is the stranded wire according to the first or fourth aspect in which, the stranded wire body includes a central strand and a plurality of strand layers, the central strand including one strand of the plurality of strands, the plurality of strand layers concentrically surrounding the central strand and each including at least two strands of the plurality of strands. The plurality of strand layers include a metal strand layer and a resin strand layer, the metal strand layer including a plurality of metal wires each of which is the metal wire, the resin strand layer including a plurality of resin fibers.

Furthermore, for example, a stranded wire according to a sixth aspect of the present invention is the stranded wire according to any one of the first to fifth aspects in which, the stranded wire body has a tensile strength of 2300 MPa or higher.

Furthermore, for example, a stranded wire according to a seventh aspect of the present invention is the stranded wire according to any one of the first to fifth aspects in which, the stranded wire body has a tensile strength of 3200 MPa or higher.

Furthermore, for example, a stranded wire according to an eighth aspect of the present invention is the stranded wire according to any one of the first to seventh aspects in which, the resin film is an electrodeposited film.

Furthermore, for example, a stranded wire according to a ninth aspect of the present invention is the stranded wire according to any one of the first to eighth aspects in which, the stranded wire is used as an electrical wire.

Furthermore, for example, a robot according to a tenth aspect of the present invention includes the stranded wire according to any one of the first to eighth aspects used as the electrical wire, the electrical wire being connected to a driver.

### REFERENCE SIGNS LIST

1, 1A, 1B, 1C, 1D stranded wire
10, 10A, 10B metal stranded wire
10C, 10D stranded wire body
11 metal wire
12 resin fiber
15 hollow section
17a, 17b, 17c strand layer
20 resin film
200 robot
210 driver

1. A stranded wire comprising:
a stranded wire body including a plurality of strands that are twisted together, the plurality of strands including a metal wire containing tungsten as a principal component; and
a resin film that covers a surface of the stranded wire body,
wherein a ratio of a thickness of the resin film to a wire diameter of the stranded wire body is 8% or higher.

2. The stranded wire according to claim 1, wherein
the stranded wire body is a metal stranded wire including the plurality of strands each of which is the metal wire.

3. The stranded wire according to claim 1, wherein
the stranded wire body includes a hollow section located at a center of the stranded wire body, and
the plurality of strands surround the hollow section.

4. The stranded wire according to claim 1, wherein
the plurality of strands include a resin fiber located at a center of the stranded wire body and a plurality of metal wires surrounding the resin fiber, the plurality of metal wires each being the metal wire.

5. The stranded wire according to claim 1, wherein
the stranded wire body includes a central strand and a plurality of strand layers, the central strand including one strand of the plurality of strands, the plurality of strand layers concentrically surrounding the central strand and each including at least two strands of the plurality of strands, and
the plurality of strand layers include a metal strand layer and a resin strand layer, the metal strand layer including a plurality of metal wires each of which is the metal wire, the resin strand layer including a plurality of resin fibers.

6. The stranded wire according to claim 2, wherein
the stranded wire body has a tensile strength of 2300 MPa or higher.

7. The stranded wire according to claim 2, wherein
the stranded wire body has a tensile strength of 3200 MPa or higher.

8. The stranded wire according to claim 1, wherein
the resin film is an electrodeposited film.

9. The stranded wire according to claim 1, wherein
the stranded wire is used as an electrical wire.

10. A robot comprising:
the stranded wire according to claim 9 used as the electrical wire, the electrical wire being connected to a driver.
